(19) United States
(12) Patent Application Publication
(10) Pub. No.: US 2025/0362476 A1
(43) Pub. Date: Nov. 27, 2025

(54) CONTROL APPARATUS, LENS APPARATUS, IMAGE PICKUP APPARATUS, AND STORAGE MEDIUM

(71) Applicant: CANON KABUSHIKI KAISHA, Tokyo (JP)

(72) Inventor: Hiromi IN, Tochigi (JP)

(21) Appl. No.: 19/186,829

(22) Filed: Apr. 23, 2025

(30) Foreign Application Priority Data
May 27, 2024 (JP) 2024-085274

(51) Int. Cl. G02B 7/10; G02B 7/02; G02B 7/09; G02B 7/14; G02B 7/28

(52) U.S. Cl. CPC G02B 7/102; G02B 7/021; G02B 7/023; G02B 7/09; G02B 7/14; G02B 7/282

(57) ABSTRACT

A control apparatus configured to control a first optical element and a second optical element that are movable in an optical axis direction includes at least one processor that executes instructions to move at least one of the first optical element and the second optical element to a target position, and correct a control error of the target position by moving the first optical element or the second optical element in the optical axis direction. The processor is configured to switch between using the first optical element and using the second optical element to correct the control error of the target position.

### BACKGROUND

### Technical Field

The present disclosure relates to a control apparatus, a lens apparatus, an image pickup apparatus, and a storage medium.

### Description of Related Art

Some conventional lens apparatuses drive a plurality of lenses, such as a zoom lens and a focus lens, using motor control. Moving the plurality of lenses may have correction drive to reduce their control errors. Japanese Patent Application Laid-Open No. 2012-073584 discloses a lens apparatus that performs correction drive to move a second focus lens having a higher resolution so as to cancel out focus shift caused by a position deviation of a first focus lens having a lower resolution.

### SUMMARY

A control apparatus according to one aspect of the disclosure configured to control a first optical element and a second optical element that are movable in an optical axis direction includes at least one processor that executes instructions to move at least one of the first optical element and the second optical element to a target position, and correct a control error of the target position by moving the first optical element or the second optical element in the optical axis direction. The processor is configured to switch between using the first optical element and using the second optical element to correct the control error of the target position. A lens apparatus and an image pickup apparatus each having the above control apparatus also constitute another aspect of the disclosure. A control method corresponding to the above control apparatus also constitutes another aspect of the disclosure. A storage medium storing a program that causes a computer to execute the above control method also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a configuration diagram of an imaging system according to a first embodiment.

FIG. 2 is a configuration diagram of a lens control unit according to the first embodiment.

FIGS. 3A and 3B explain a method of switching a correction drive lens according to the first embodiment.

FIG. 4 is a flowchart of the method of switching the correction drive lens according to the first embodiment.

FIGS. 5A and 5B explain a method of switching a correction drive lens according to a second embodiment.

FIG. 6 is a flowchart of the method of switching the correction drive lens according to the second embodiment.

FIGS. 7A and 7B explain a method of switching a correction drive lens according to a third embodiment.

FIG. 8 is a flowchart of the method of switching the correction drive lens according to the third embodiment.

FIGS. 9A and 9B explain a method of switching a correction drive lens according to a fourth embodiment.

FIG. 10 is a flowchart of the method of switching the correction drive lens according to the fourth embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

### First Embodiment

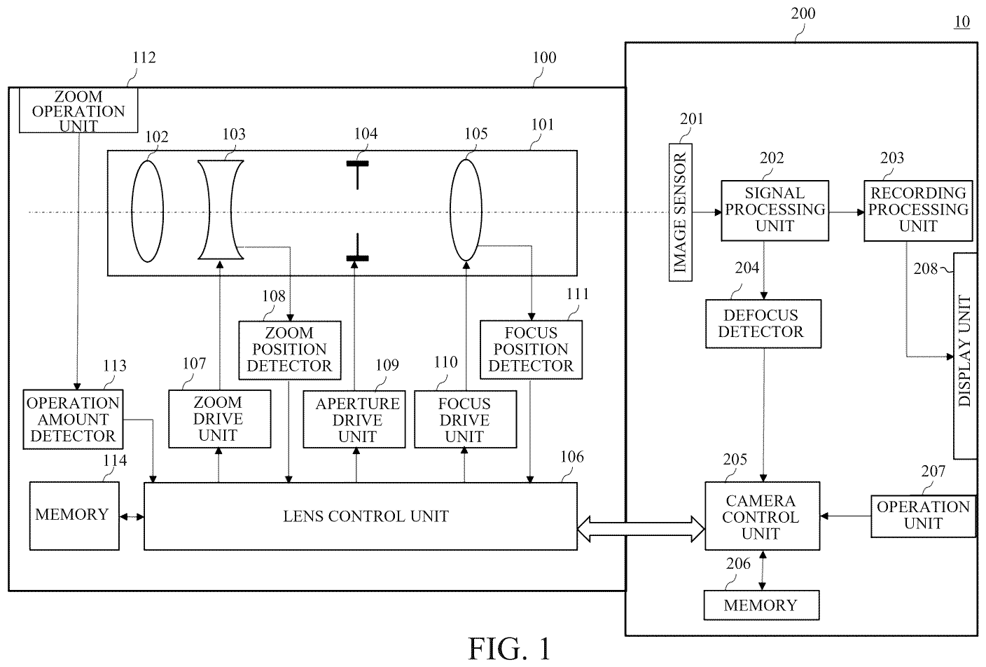

Referring now to FIG. 1, a description will be given of an imaging system 10 according to a first embodiment of the present disclosure. FIG. 1 is a configuration diagram of the imaging system 10. The imaging system 10 is an lens interchangeable type camera system including an image pickup apparatus (camera body) 200 and a lens apparatus (interchangeable lens) 100 that is attachable to and detachable from the image pickup apparatus 200. The image pickup apparatus 200 and the lens apparatus 100 are mechanically and electrically connected via an unillustrated mount. The image pickup apparatus 200 supplies power to the lens apparatus 100 via a power terminal portion provided on the unillustrated mount. The image pickup apparatus 200 communicates with the lens apparatus 100 via a communication terminal portion provided on the unillustrated mount. This embodiment is not limited to this example, and is applicable to an image pickup apparatus in which the camera body and the lens apparatus are integrated.

The image pickup apparatus 200 includes an image sensor 201, a signal processing unit 202, a recording processing unit 203, a defocus detector 204, a camera control unit 205, a memory 206, an operation unit 207, and a display unit 208.

The image sensor 201 receives light from an optical system 101, generates an electric signal (analog signal) by photoelectric conversion, and outputs it to the signal processing unit 202. The image sensor 201 has pixels for imaging (imaging pixels) as well as pixels for detecting an unillustrated in-focus position (focus detecting pixels). The signal processing unit 202 converts an electric signal (analog signal) from the image sensor 201 into a digital signal. The signal processing unit 202 performs various image processing such as noise removal and color correction for the digital signal, and outputs it to the recording processing unit 203. The recording processing unit 203 records the input image and displays the image on the display unit 208. The defocus detector 204 detects an in-focus state of an object image using the image sensor 201.

The imaging system 10 according to this embodiment detects a defocus amount by a phase-difference detecting method. The defocus detector 204 detects a phase difference between signals representing a pair of object images obtained from light incident on the focus detecting pixels of the image sensor 201 through a microlens that performs pupil division, and determines a defocus amount corresponding to the phase difference. The defocus detector 204 then outputs the detected defocus amount to the camera control unit 205.

The camera control unit 205 includes a computer having a CPU, and is electrically connected to the defocus detector 204, memory 206, and operation unit 207. The camera control unit 205 reads (loads) and executes a program recorded in the memory 206. The camera control unit 205 communicates information on a camera type or information for autofocus (AF) control with the lens control unit 106. The camera control unit 205 controls the image pickup apparatus 200 in accordance with input from a camera operation unit including an imaging instruction switch and various setting switches (not illustrated). The camera control unit 205 controls an unillustrated mechanical shutter in accordance with a shutter mode set via the operation unit 207 to adjust an exposure amount to the image sensor 201. The camera control unit 205 generates a drive command for the focus lens based on the detection result from the defocus detector 204 and the current position of the focus lens acquired from the attached lens apparatus 100.

The lens apparatus 100 includes the optical system 101 that can form an optical image of an object on the image sensor 201 in the image pickup apparatus 200. The optical system 101 includes, in order from the object side to the image side, a field lens 102, a magnification-varying lens (zoom lens, i.e., a lens that moves during zooming) 103, an aperture unit 104, and a focus lens (a lens that moves during focusing) 105. In this embodiment, the lens apparatus 100 is a zoom lens with a variable focal length.

The field lens 102 adjusts a traveling direction of peripheral light in the object image. The magnification-varying lens 103 is moved in the optical axis direction by driving an actuator such as an ultrasonic motor via a zoom drive unit 107 after an operation by a zoom operation unit 112 is detected with an operation amount detector 113. Thereby, the focal length of the lens apparatus 100 is changed. The position of the magnification-varying lens 103 is detected by a zoom position detector 108. An aperture unit 104 includes unillustrated aperture blades, and an aperture drive unit 109 moves an actuator such as a stepping motor to adjust a light amount. The focus lens 105 is moved in the optical axis direction by driving an actuator such as an ultrasonic motor via a focus drive unit 110 to adjust the in-focus state, and the position is detected by a focus position detector 111.

A memory 114 is a storage unit for storing information, and includes a read only memory (ROM), a random access memory (RAM), etc. The memory 114 stores information on a relationship among designed positions of the magnification-varying lens 103 and the focus lens 105, an object distance, and a focal length. The memory 114 stores information on a relationship among optical information such as the focus sensitivity and aberration sensitivity of each of the magnification-varying lens 103 and the focus lens 105, an object distance, and a focal length. The memory 114 stores information on a relationship among a correction limit amount of each of the magnification-varying lens 103 and the focus lens 105, an object distance, and a focal length.

The lens control unit 106 is a computer having a CPU. The lens control unit 106 is electrically connected to the zoom drive unit 107, the aperture drive unit 109, the zoom position detector 108, the focus drive unit 110, the focus position detector 111, and the memory 114.

The lens control unit 106 receives a control command from the camera control unit 205, and outputs an instruction to the focus drive unit 110 so that the focus lens 105 is driven at a predetermined drive amount and drive speed based on the received control command. The focus drive unit 110 drives the focus lens 105 to perform focusing according to a command from the lens control unit 106. This series of lens control modes is called an AF control mode.

The lens control unit 106 detects that the zoom operation unit 112 has been operated via the operation amount detector 113. The lens control unit 106 then outputs a command to the zoom drive unit 107 to drive the magnification-varying lens 103 at a drive amount and drive speed according to the operation direction and operation amount of the zoom operation unit 112 using a signal from the operation amount detector 113. As the magnification-varying lens 103 fluctuates, the focal length fluctuates and a focus position at which the lens is in focus changes. Thus, the focus drive unit 110 drives the focus lens 105 according to a command from the lens control unit 106 based on the designed position information stored in the memory 114, and also performs focusing. This series of lens control modes is called a zoom control mode.

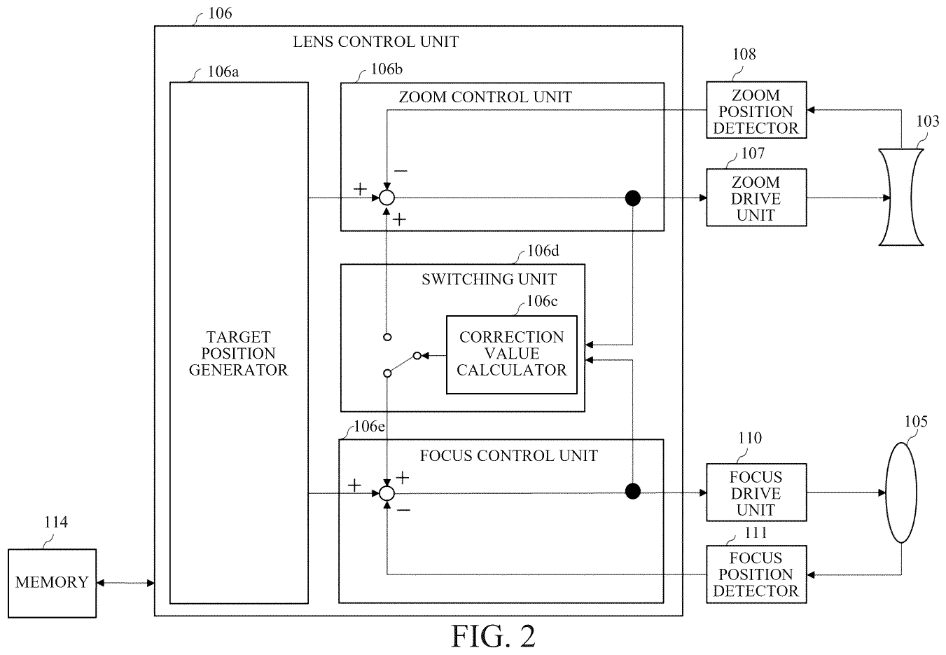

Referring now to FIG. 2, a description will be given of the lens control unit 106 according to this embodiment. FIG. 2 is a configuration diagram of the lens control unit 106. The lens control unit 106 is a control apparatus configured to control a first optical element (e.g., the magnification-varying lens 103) and a second optical element (e.g., the focus lens 105) that can move in the optical axis direction. The lens control unit 106 includes a target position generator 106a, a zoom control unit 106b, a correction value calculator 106c, a switching unit 106d, and a focus control unit 106e. In FIG. 2, the aperture drive unit 109 is omitted in order to focus on the focus control.

The target position generator 106a generates a target zoom position and a target focus position at a predetermined control period based on a drive amount output from the camera control unit 205 or the operation amount detector 113 to the lens control unit 106. This embodiment generates the target positions such that the target zoom position and the target focus position have the same focal length and the same object distance, respectively.

The zoom control unit 106b calculates a zoom position deviation (a difference between the target zoom position and the actual zoom position) based on the target zoom position acquired via the target position generator 106a and the actual zoom position acquired via the zoom position detector 108. In a case where a zoom correction value Cx is output from the correction value calculator 106c, the zoom control unit 106b adds the zoom correction value Cx to the zoom position deviation. The zoom control unit 106b outputs the calculated zoom position deviation to the switching unit 106d. The zoom control unit 106b multiplies the calculated zoom position deviation, for example, by a PID gain to convert it into a zoom operation amount and outputs it to the zoom drive unit 107.

The correction value calculator 106c calculates a correction value based on the zoom position deviation calculated by the zoom control unit 106b or the focus position deviation calculated by the focus control unit 106e, and the zoom focus sensitivity and focus sensitivity stored in the memory 114. In a case where the correction is performed by the zoom control unit 106b, the correction value calculator 106c calculates the zoom correction value Cx by the following equation (1) based on the focus position deviation ΔDy, the zoom focus sensitivity α, and the focus sensitivity β:

Cx=ΔDy(α/β) (1)

In a case where the correction is performed by the focus control unit 106e, the correction value calculator 106c calculates the focus correction value Cy by the following equation (2) based on the zoom position deviation ΔDx, the zoom focus sensitivity α, and the focus sensitivity β:

Cy=ΔDx(β/α) (2)

The switching unit 106d inputs the zoom position deviation and the focus position deviation into the correction value calculator 106c. The switching unit 106d switches between the zoom control unit 106b and the focus control unit 106e, to which the zoom correction value Cx or the focus correction value Cy calculated by the correction value calculator 106c is output, according to the condition. The switching condition will be described later.

The focus control unit 106e calculates a focus position deviation (a difference between the target focus position and the actual focus position) based on the target focus position acquired by the target position generator 106a and the actual focus position acquired by the focus position detector 111. In a case where the focus correction value Cy is output from the correction value calculator 106c, the focus control unit 106e adds the focus correction value Cy to the focus position deviation. The focus control unit 106e outputs the calculated focus position deviation to the switching unit 106d. The focus control unit 106e multiplies the calculated focus position deviation, for example, by a PID gain, to convert it into a focus operation amount to be output to the focus drive unit 110, and outputs it to the focus drive unit 110.

The zoom control unit 106b and the focus control unit 106e function as a control unit configured to move at least one of the first optical element and the second optical element to a target position. The switching unit 106d functions as a correction unit configured to correct a target position (a control error at a target position) by moving one of the first optical element and the second optical element in the optical axis direction. The switching unit (correction unit) 106d switches between using the first optical element and using the second optical element to correct the target position (control error of the target position).

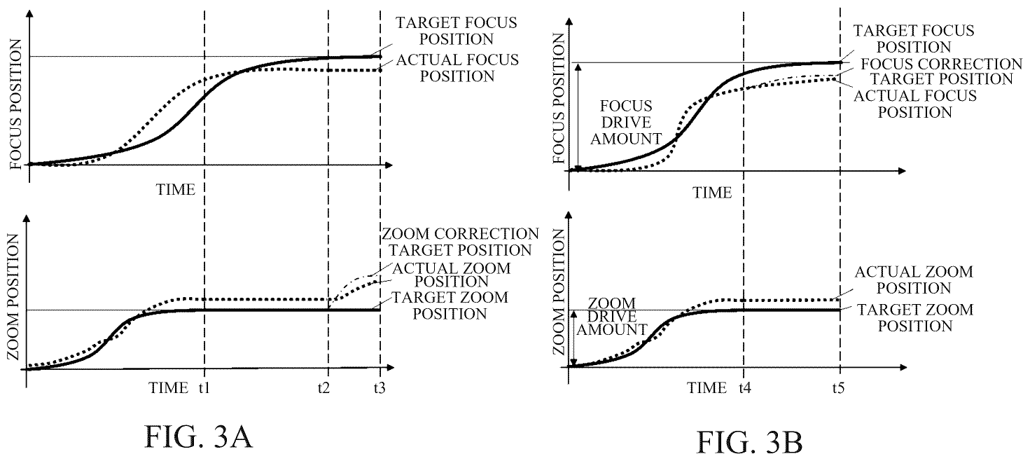

Referring now to FIGS. 3A and 3B, a description will be given of a method for switching a correction drive lens based on a drive amount according to this embodiment. This embodiment discusses the zoom lens (magnification-varying lens 103) as having a lower focus sensitivity than that of the focus lens 105, but is not limited to this example.

FIG. 3A explains the time series results in a case where correction drive is performed with the zoom lens. In FIG. 3A, a horizontal axis represents time, and a vertical axis represents a focus position and a zoom position, respectively. Here, as in the conventional method, the focus sensitivity of the focus lens and the zoom lens are compared, and correction drive is performed with the zoom lens having the lower sensitivity.

First, the driving of the zoom lens is completed at time t1. Thereafter, the driving of the focus lens is completed at time t2. Then, a correction drive value is calculated based on the determined focus position deviation and a focus sensitivity ratio of the focus lens and the zoom lens, and correction drive is performed with the zoom lens until time t3. At this time, since correction drive is performed with a lens with a lower focus sensitivity, a large correction drive value is calculated, and an image plane error can be corrected at finer resolution. However, since the correction drive value is determined at time t2 and the correction drive is completed at time t3, extra drive time is generated for the correction drive.

FIG. 3B explains the time series results in a case where correction drive is performed with the focus lens. In FIG. 3B, a horizontal axis represents time, and a vertical axis represents a focus position and a zoom position, respectively. Here, the focus drive amount and the zoom drive amount are compared, and correction drive is performed with the focus lens with the larger drive amount.

Since the zoom lens has a smaller drive amount, at time t4, the zoom lens completes driving before the focus lens. Here, a correction drive value is calculated based on the determined zoom position deviation and the focus sensitivity ratio of the focus lens and the zoom lens, and correction drive is performed with the focus lens until time t5. Thus, the drive time can be reduced by performing the correction drive of the other lens with a larger drive amount and slower drive completion based on a correction drive value calculated based on one lens with a smaller drive amount and faster drive completion.

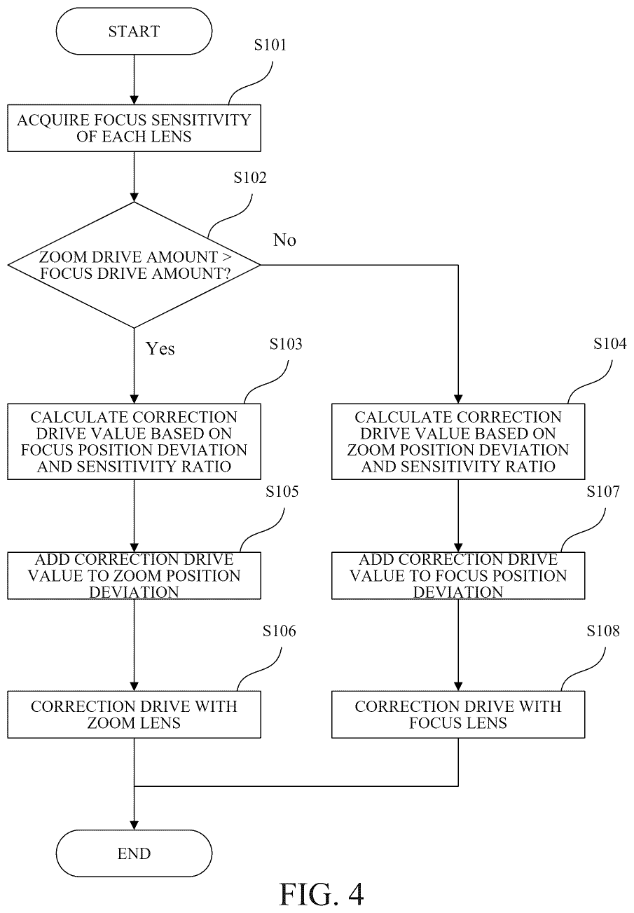

Referring now to FIG. 4, a description will be given of a method of switching a correction drive lens based on a drive amount according to this embodiment. FIG. 4 is a flowchart of the correction drive lens switching method. Each step in FIG. 4 is mainly executed by the lens control unit 106.

First, in step S101, the lens control unit 106 acquires the focus sensitivity of each lens, that is, the focus sensitivity and the zoom focus sensitivity, via the memory 114. Next, in step S102, the lens control unit 106 determines whether or not the zoom drive amount (first drive amount) is larger than the focus drive amount (second drive amount). In a case where it is determined that the zoom drive amount is larger than the focus drive amount, the flow proceeds to step S103. On the other hand, in a case where it is determined that the zoom drive amount is not larger than the focus drive amount, the flow proceeds to step S104.

In step S103, the lens control unit 106 calculates a correction value (correction drive value) based on the focus position deviation and the ratio (sensitivity ratio) between the focus sensitivity and the zoom sensitivity. Then, in step S105, the lens control unit 106 adds the correction drive value to the zoom position deviation. Next, in step S106, the lens control unit 106 multiplies the zoom position deviation to which the correction drive value has been added in step S105, by a PID gain or the like to convert it into a zoom operation amount to be output to the zoom drive unit 107. Then, the lens control unit 106 outputs the zoom operation amount to the zoom drive unit 107 and drives the magnification-varying lens 103 (performing correction drive with the zoom lens as the first optical element).

In step S104, the lens control unit 106 calculates a correction value (correction drive value) based on the zoom position deviation and the ratio (sensitivity ratio) between the zoom sensitivity and the focus sensitivity. Next, in step S107, the lens control unit 106 adds the correction drive value to the focus position deviation. Next, in step S108, the lens control unit 106 multiplies the focus position deviation to which the correction drive value has been added in step S107, by a PID gain or the like to convert it into a focus operation amount to be output to the focus drive unit 110. Then, the lens control unit 106 outputs the focus operation amount to the focus drive unit 110 and drives the focus lens 105 (performing correction drive with the focus lens as the second optical element).

As described above, in this embodiment, the switching unit 106d switches between using the first optical element and using the second optical element to correct the target position, according to the first drive amount of the first optical element and the second drive amount of the second optical element. In a case where the first drive amount is larger than the second drive amount, the switching unit 106d may correct the target position using the first optical element. In a case where the second drive amount is larger than the first drive amount, the switching unit 106d corrects the target position using the second optical element.

This embodiment switches the lens for which the correction drive is to be performed, according to the drive amount, but is not limited to this example, and the lens for which the correction drive is to be performed may be switched according to the electrification state. For example, it may be determined based on the electrification state that the zoom lens has completed driving first, and the focus lens may be used for the correction drive. That is, the switching unit 106d may switch between using the first optical element and using the second optical element to correct the target position, according to the first electrification state of the first optical element and the second electrification state of the second optical element. In a case where the first electrification state is an electrification ongoing state and the second electrification state is a non-electrification state, the switching unit 106d may correct the target position using the first optical element. In a case where the second electrification state is an electrification ongoing state and the first electrification state is a non-electrification state, the switching unit 106d corrects the target position using the second optical element.

### Second Embodiment

A second embodiment according to the present disclosure will now be described. This embodiment switches the lens for which the correction drive is to be performed, according to a correctable amount. This embodiment assumes that the focus sensitivity of the zoom lens (magnification-varying lens 103) is lower than that of the focus lens 105. This embodiment also assumes that the focus sensitivity of the focus lens 105 is lower than that of the zoom lens (magnification-varying lens 103). However, this embodiment is not limited to this example.

In this embodiment, in a case where the magnification-varying lens 103 and the focus lens 105 are moved toward the image sensor, an in-focus state is obtained for an object on the close distance side. On the other hand, in a case where the magnification-varying lens 103 and the focus lens 105 are moved toward the object, an in-focus state is obtained for an object on the infinity side.

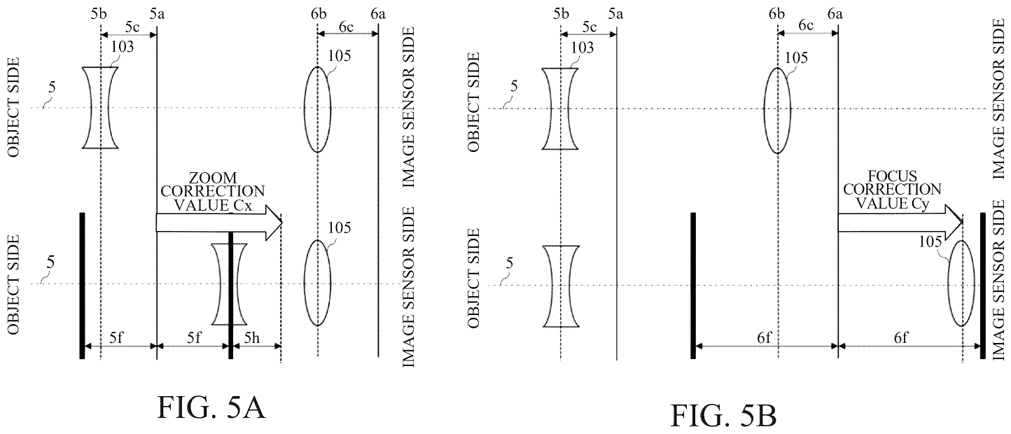

A method of switching a correction drive lens based on a correctable amount according to this embodiment will be described with reference to FIGS. 5A and 5B. FIG. 5A explains an example in which correction drive is performed with a zoom lens with lower focus sensitivity. FIG. 5A illustrates a target zoom position 5a and an actual zoom position 5b, which are positions on an optical axis 5, and also illustrates a zoom position deviation 5c, which is a difference between them. FIG. 5A also illustrates a target focus position 6a and an actual focus position 6b, as well as a focus position deviation 6c.

The target zoom position 5a and the target focus position 6a are positions where an in-focus state is obtained at the same focal length and the same object distance. At this time, the focus lens 105 is shifted toward the infinity side from the target focus position 6a by the focus position deviation 6c, so that the object image is formed at a position shifted toward the infinity side relative to the image sensor 201. Thus, a focus shift occurs.

Then, the lens control unit 106 (correction value calculator 106c) corrects the focus shift caused by the control error of the focus lens 105 by correcting and driving the magnification-varying lens 103 by the calculable zoom correction value Cx based on equation (1).

However, in a case where the magnification-varying lens 103 is shifted too far from the target zoom position 5a for the correction drive, it is considered that large spherical aberration will occur, so the correction may be made within a zoom correction limit range 5f that does not affect the aberration. At this time, a focus error equivalent to a correction residual 5h occurs relative to the original zoom correction value Cx.

FIG. 5B explains an example in which correction driving is performed with a focus lens with higher focus sensitivity. In FIG. 5B, the magnification-varying lens 103 is shifted toward the infinity side by a zoom position deviation 5c relative to the target zoom position 5a. Therefore, an object image is formed at a position shifted toward the infinity side relative to the image sensor 201, Therefore, a focus error occurs.

Accordingly, the lens control unit 106 (correction value calculator 106c) performs correction drive for the focus lens 105 by the focus correction value Cy that can be calculated based on equation (2), and thereby the focus error caused by the control error of the magnification-varying lens 103 can be corrected.

In this embodiment, the focus lens has a lower aberration sensitivity. Therefore, a focus correction limit range of that does not affect the aberration can be set in a range larger than the zoom correction limit range 5f. Therefore, in some cases, a correction residual does not occur and focus error can be suppressed more effectively than in a case where a correction drive is performed with a zoom lens with low focus sensitivity.

A description will now be given of a method of comparing the correctable amounts of the zoom lens and the focus lens. First, in a case where the zoom correction value Cx calculated by equation (1) is greater than the zoom correction limit amount Lx stored in the memory 114, the zoom correction residual ΔRx is calculated by the following equation (3):

ΔRx=Cx−Lx (3)

Next, the focus shift ΔPx to be corrected by the zoom lens is calculated by the following equation (4) using the zoom correction residual ΔRx calculated by equation (3) and the zoom focus sensitivity α.

ΔPx=|ΔRx·α| (4)

Similarly, in a case where the focus correction value Cy calculated by equation (2) is greater than the focus correction limit amount Ly stored in the memory 114, the focus correction residual ΔRy is calculated by the following equation (5):

ΔRy=Cy−Ly (5)

Next, the focus correction residual ΔRy calculated by equation (5) and the focus sensitivity β are used to calculate the focus shift ΔPy to be corrected with the focus lens by the following equation (6).

ΔPy=|ΔRy·β| (6)

Next, the focus shift ΔPx to be corrected with the zoom lens calculated by equation (4) is compared with the focus shift ΔPy to be corrected with the focus lens calculated by equation (6). Then, it may be determined that the one that can reduce the focus shift more has a larger correctable amount, and the correction drive lens may be switched.

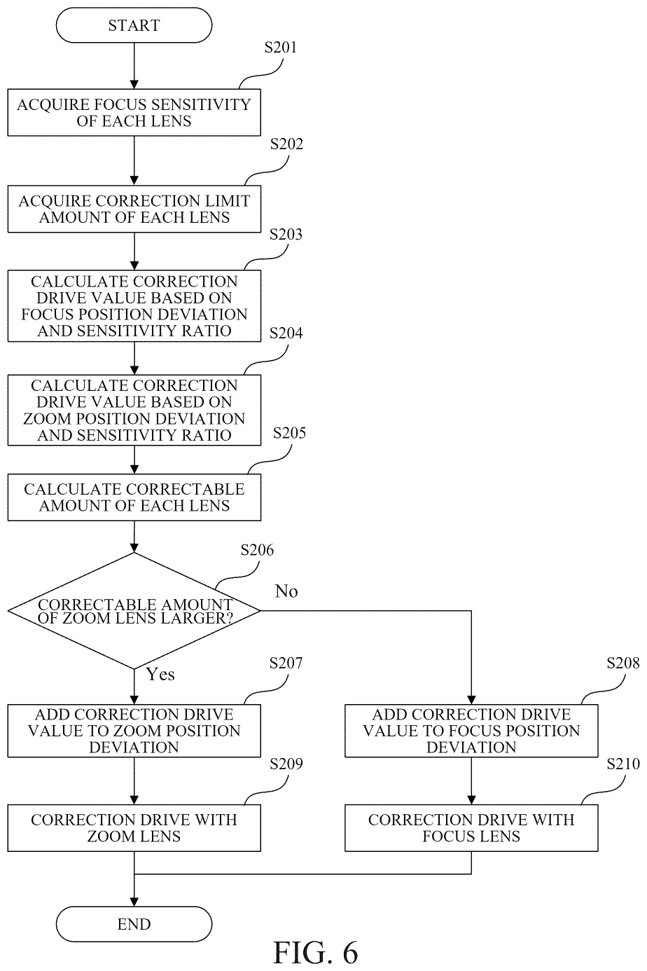

A description will now be given of the method of switching the correction drive lens based on the correctable amount according to this embodiment with reference to FIG. 6. FIG. 6 is a flowchart of the method of switching the correction drive lens based on the correctable amount. Each step in FIG. 6 is mainly executed by the lens control unit 106.

First, in step S201, the lens control unit 106 acquires the focus sensitivity and the zoom sensitivity via the memory 114. Next, in step S202, the lens control unit 106 acquires the focus correction limit amount Ly and the zoom correction limit amount Lx via the memory 114.

Next, in step S203, the lens control unit 106 calculates the zoom correction value Cx from the focus position deviation and the ratio of the focus sensitivity to the zoom sensitivity based on equation (1). Next, in step S204, the lens control unit 106 calculates the focus correction value Cy from the zoom position deviation and the ratio of the focus sensitivity to the zoom sensitivity based on equation (2).

Next, in step S205, the lens control unit 106 calculates the focus shift ΔPx to be corrected with the zoom lens based on equations (3) and (4). The lens control unit 106 calculates the focus shift ΔPy to be corrected with the focus lens based on equations (5) and (6).

Next, in step S206, the lens control unit 106 compares the focus error ΔPx to be corrected with the zoom lens with the focus error ΔPy to be corrected with the focus lens. In a case where the focus error ΔPx to be corrected with the zoom lens is smaller, the lens control unit 106 determines that the correctable amount of the zoom lens (first correctable amount) is larger than the correctable amount of the focus lens (second correctable amount), and the flow proceeds to step S207. On the other hand, in a case where the focus error ΔPy to be corrected with the focus lens is smaller, the lens control unit 106 determines that the correctable amount of the focus lens (second correctable amount) is larger than the correctable amount of the zoom lens (first correctable amount), and the flow proceeds to step S208.

In step S207, the lens control unit 106 adds the zoom correction value Cx to the zoom position deviation. Next, in step S209, the lens control unit 106 multiplies the zoom position deviation to which the correction drive value has been added in step S207, by a PID gain or the like, thereby converting it into a zoom operation amount to be output to the zoom drive unit 107. Then, the lens control unit 106 outputs the zoom operation amount to the zoom drive unit 107 and drives the magnification-varying lens 103 (performing correction drive with the zoom lens as the first optical element).

In step S208, the lens control unit 106 adds the focus correction value Cy to the focus position deviation. Next, in step S210, the lens control unit 106 multiplies the focus position deviation to which the correction drive value has been added in step S208, by a PID gain or the like, thereby converting it into a focus operation amount to be output to the focus drive unit 110. Then, the lens control unit 106 outputs the focus operation amount to the focus drive unit 110 and drives the focus lens 105 (performing correction drive with the focus lens as the second optical element).

As described above, in this embodiment, the switching unit 106d switches between using the first optical element and using the second optical element to correct the target position, according to the first correctable amount of the first optical element and the second correctable amount of the second optical element. In a case where the first correctable amount is larger than the second correctable amount, the switching unit 106d may correct the target position using the first optical element. On the other hand, in a case where the second correctable amount is larger than the first correctable amount, the switching unit 106d may correct the target position using the second optical element.

In this embodiment, each of the first correctable amount and the second correctable amount is a limit amount based on the target position, and may be different, for example, according to the object distance, the focal length, or the position of at least one of the first optical element and the second optical element.

This embodiment switches the lens that performs the correction drive according to the correctable amount, but may switch the lens that performs the correction drive according to an object distance, a focal length, a lens position, an aberration sensitivity, or the like. For example, since the magnitude of an aberration fluctuation amount due to lens fluctuation can be assumed according to the object distance, the lens for performing the correction drive may be switched between an object distance of 1 m to 3 m and an object distance of 3 m to 10 m. Similarly, the lens that performs the correction drive may be switched based on the focal length, the lens position, or the magnitude of the aberration sensitivity stored in the memory 114.

### Third Embodiment

A third embodiment according to the present disclosure will now be described. This embodiment switches the lens that performs the correction drive, according to a position deviation. This embodiment will discuss the zoom lens as having a lower focus sensitivity than that of the focus lens, but is not limited to this example. This embodiment will discuss the focus lens as having a higher resistance to disturbances such as impacts than that of the zoom lens, but is not limited to this example. This embodiment will discuss an example in which an actual zoom position changes significantly (zoom position deviation becomes large) due to disturbance factors such as impacts.

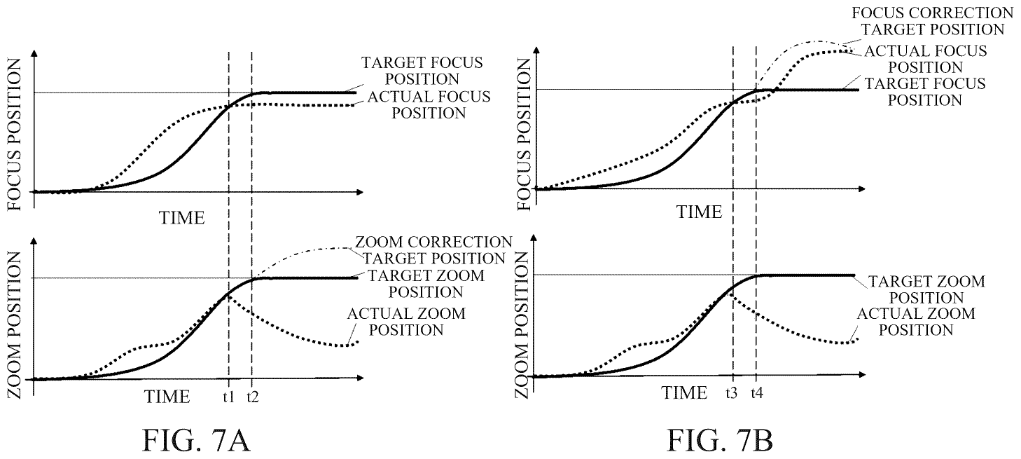

A description will now be given of an example of a method for switching the correction drive lens based on the position deviation with reference to FIGS. 7A and 7B. FIG. 7A explains time series results in a case where the correction drive is performed with a zoom lens. In FIG. 7A, a horizontal axis represents time, and a vertical axis represents a focus position and a zoom position, respectively. Here, as in the conventional configuration, the focus sensitivity of the focus lens and the zoom lens are compared, and correction drive is performed with the zoom lens which has the lower sensitivity.

First, at time t1, the actual zoom position changes significantly due to a disturbance such as an impact. Next, at time t2, the driving of the focus lens is completed, and a correction drive value is calculated based on the determined focus position deviation and the focus sensitivity ratio of the focus lens and the zoom lens, and correction drive is performed with the zoom lens. However, due to the disturbance that occurred at time t1, a shift occurs between the zoom correction target position and the actual zoom position, and the intended correction drive is not performed, and the focus shift cannot be reduced.

FIG. 7B explains the time series results in a case where correction drive is performed with the focus lens. In FIG. 7B, a horizontal axis represents time, and a vertical axis represents a focus position and a zoom position, respectively. At time t3, the actual zoom position changes significantly due to a disturbance such as an impact. After time t4 and subsequent time, the occurrence of a disturbance due to an impact or the like can be estimated by detecting that the zoom position deviation is equal to or greater than a predetermined value. Therefore, after the driving of the focus lens is completed at time t4, a correction drive value is calculated based on the zoom position deviation and the focus sensitivity ratio of the focus lens and the zoom lens, and correction drive is performed with the focus lens.

Thus, in a case where the position deviation is large and correction drive is difficult to perform due to a disturbance such as an impact, a focus shift can be reduced in some cases through stable correction drive by performing correction drive for the other lens with the smaller position deviation.

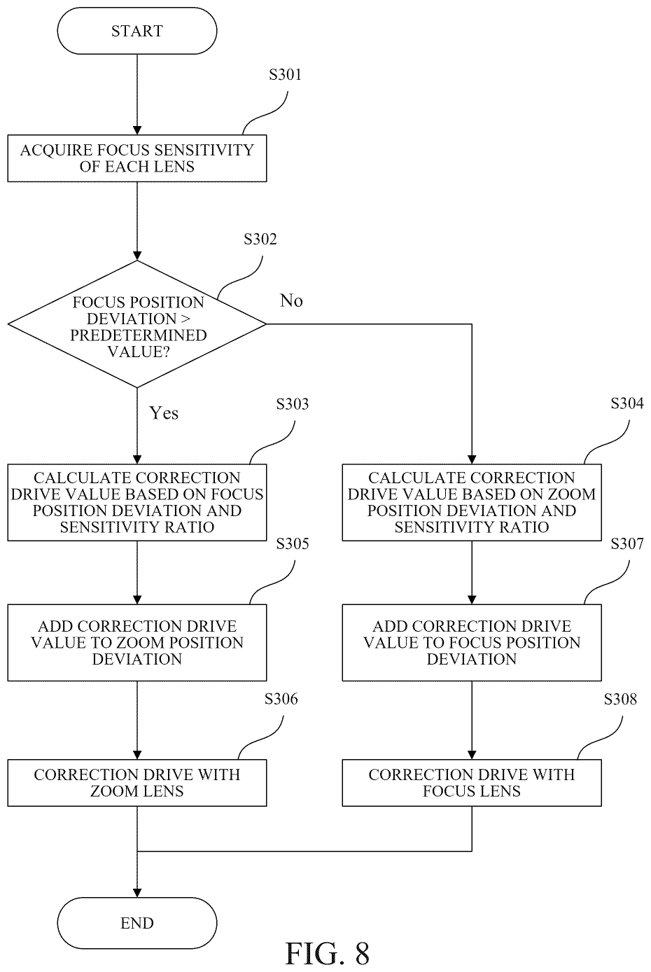

Referring now to FIG. 8, a description will be given of a method of switching the correction drive lens based on the position deviation according to this embodiment. FIG. 8 is a flowchart of the method of switching the correction drive lens based on the position deviation. Each step in FIG. 8 is mainly executed by the lens control unit 106.

First, in step S301, the lens control unit 106 acquires the focus sensitivity and the zoom sensitivity via the memory 114. Next, in step S302, the lens control unit 106 determines whether the focus position deviation (first position deviation) is greater than a predetermined value. In a case where it is determined that the focus position deviation is greater than the predetermined value, the flow proceeds to step S303. On the other hand, in a case where it is determined that the focus position deviation is not greater than the predetermined value, the flow proceeds to step S304.

In step S303, the lens control unit 106 calculates a correction value (correction drive value) from the focus position deviation and the ratio between the focus sensitivity and the zoom sensitivity. Then, in step S305, the lens control unit 106 adds the correction drive value to the zoom position deviation. Then, in step S306, the lens control unit 106 multiplies the zoom position deviation to which the correction drive value has been added in step S305, by a PID gain or the like to convert it into a zoom operation amount to be output to the zoom drive unit 107. Then, the lens control unit 106 outputs the zoom operation amount to the zoom drive unit 107 and drives the magnification-varying lens 103 (performing correction drive with the zoom lens as the first optical element).

In step S304, the lens control unit 106 calculates a correction value (correction drive value) from the zoom position deviation and the ratio between the zoom focus sensitivity and the focus sensitivity. Next, in step S307, the lens control unit 106 adds the correction drive value to the focus position deviation. Then, in step S308, the lens control unit 106 multiplies the focus position deviation to which the correction drive value has been added in step S307, by a PID gain or the like to convert it into a focus operation amount to be output to the focus drive unit 110. Then, the lens control unit 106 outputs the focus operation amount to the focus drive unit 110 and drives the focus lens 105 (performing correction drive with the focus lens as the second optical element).

As described above, in this embodiment, the switching unit 106d switches between using the first optical element and using the second optical element to correct the target position, according to at least one of the first position deviation of the first optical element and the second position deviation of the second optical element. The switching unit 106d may correct the target position using the first optical element in a case where the first position deviation is smaller than a predetermined value. On the other hand, the switching unit 106d may correct the target position using the second optical element in a case where the first position deviation is larger than the predetermined value.

Alternatively, the lens for correction drive may be switched according to whether the second position deviation of the second optical element is larger than the predetermined value. That is, the switching unit 106d may correct the target position using the second optical element in a case where the second position deviation is smaller than the predetermined value. On the other hand, the switching unit 106d may correct the target position using the first optical element in a case where the second position deviation is larger than the predetermined value.

Alternatively, the lens for correction drive may be switched according to a magnitude relationship between the first position deviation of the first optical element and the second position deviation of the second optical element. That is, the switching unit 106d may correct the target position using the first optical element in a case where the first position deviation is smaller than the second position deviation. On the other hand, in a case where the second position deviation is smaller than the first position deviation, the switching unit 106d may correct the target position using the second optical element.

This embodiment switches the lens for correction drive according to the position deviation, but may switch the lens for correction drive based on the attached camera information (the type of image pickup apparatus 200 attached to the lens apparatus 100) received from the camera control unit 205. For example, in a case where it is expected that the combination with the attached image pickup apparatus 200 is susceptible to external disturbance factors such as an impact, the lens for correction drive may be switched.

The lens for correction drive may be switched according to the shutter mode received from the camera control unit 205. For example, in the shutter mode of the camera body, in a mode where the mechanical shutter is driven, it is expected that an impact will occur due to the shutter drive, so the lens for correction drive may be switched.

The lens for correction drive may be switched according to the attitude, temperature, driving number, etc. of the lens apparatus or the camera body. For example, in a case where the operation during correction drive is affected according to the attitude, temperature, or driving number, this embodiment may switch the lens that performs the correction drive to a lens that is less affected.

### Fourth Embodiment

A fourth embodiment according to the present disclosure will now be described. This embodiment switches the lens that performs the correction drive according to the lens control mode. This embodiment will discuss the zoom lens as having a lower focus sensitivity than that of the focus lens, but is not limited to this example.

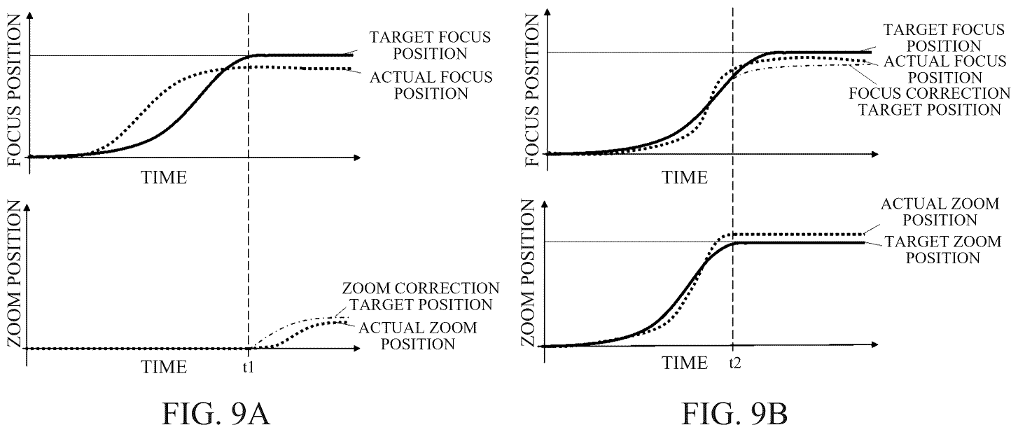

A description will now be given of an example of switching the correction drive lens based on the lens control mode in this embodiment with reference to FIGS. 9A and 9B. FIG. 9A explains the time series results in a case where correction drive is performed with a zoom lens in the AF control mode. In FIG. 9A, a horizontal axis represents time, and a vertical axis represents a focus position and a zoom position, respectively. In the AF control mode, the focal length is fixed, and first only the focus lens is driven so that the target object is focused.

After the driving of the focus lens is completed at time t1, it is considered that correction drive is performed with a zoom lens with a lower sensitivity. Therefore, a correction drive value is calculated based on the focus position deviation finalized at time t1 and the focus sensitivity ratio between the focus lens and the zoom lens, and correction drive is performed with the zoom lens. Thus, in the AF control mode, in a case where the zoom lens has a lower focus sensitivity, correction drive may be performed with the zoom lens as in the conventional configuration.

FIG. 9B explains the time series results in a case where correction drive is performed with the focus lens in the zoom control mode. In FIG. 9B, a horizontal axis represents time, and a vertical axis represents a focus position and a zoom position, respectively. In the zoom control mode, the zoom lens is driven along with a focal length change caused by the zoom operation. In a case where a focus position at which the in-focus state is achieved changes along with the focal length change, the focus lens is also driven to a predetermined position. At this time, after the zoom operation is completed, a target focus position at which the in-focus state is achieved is calculated based on a focal length finalized when the zoom lens stops driving. Thus, it is expected that the focus lens will complete driving later. Therefore, performing correction drive with a focus lens with high focus sensitivity is more likely to reduce the drive time.

In FIG. 9B, after the driving of the zoom lens is completed at time t2, a correction drive value is calculated based on the zoom position deviation and the focus sensitivity ratio of the focus lens and the zoom lens, and the correction drive is performed with the focus lens. Thus, by switching the lens that performs the correction drive according to the lens control mode, the reduction of the drive time can be expected in some cases.

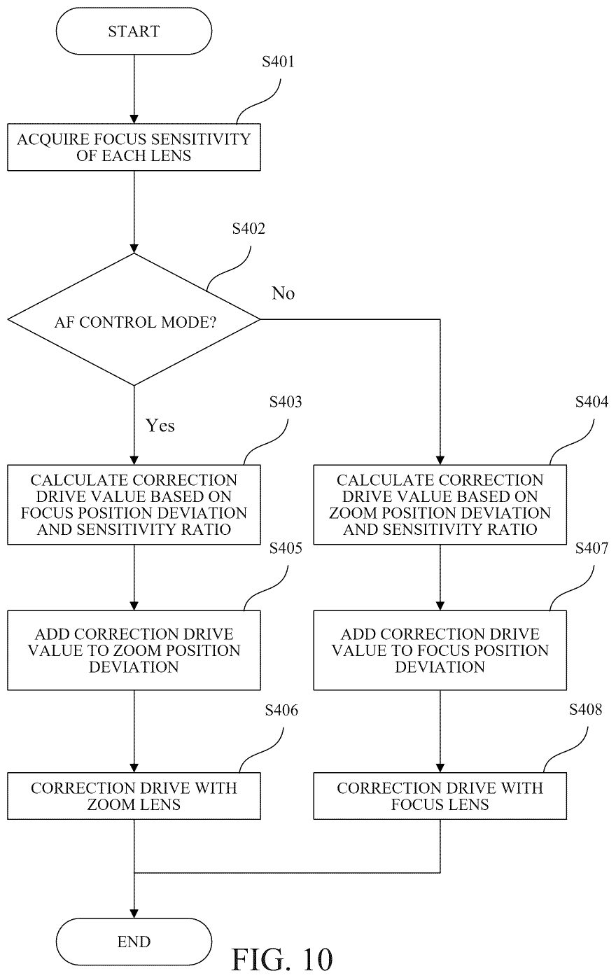

Referring now to FIG. 10, a description will be given of a method of switching the correction drive lens based on the lens control mode according to this embodiment. FIG. 10 is a flowchart of the method of switching the correction drive lens based on the lens control mode. Each step in FIG. 10 is mainly executed by the lens control unit 106.

First, in step S401, the lens control unit 106 acquires the focus sensitivity and the zoom sensitivity via the memory 114. Next, in step S402, the lens control unit 106 determines whether the lens control mode is the AF control mode. In a case where it is determined that the lens control mode is the AF control mode, the flow proceeds to step S403. On the other hand, in a case where it is determined that the lens control mode is not the AF control mode, the lens control unit 106 determines that the lens control mode is the zoom control mode, and the flow proceeds to step S404.

In step S403, the lens control unit 106 calculates a correction value (correction drive value) from the focus position deviation and the ratio between the focus sensitivity and the zoom focus sensitivity. Then, in step S405, the lens control unit 106 adds the correction drive value to the zoom position deviation. Then, in step S406, the lens control unit 106 multiplies the zoom position deviation to which the correction drive value has been added in step S405, by a PID gain or the like, thereby converting it into a zoom operation amount to be output to the zoom drive unit 107. Then, the lens control unit 106 outputs the zoom operation amount to the zoom drive unit 107 and drives the magnification-varying lens 103 (performing correction drive with the zoom lens as the first optical element).

In step S404, the lens control unit 106 calculates a correction value (correction drive value) from the zoom position deviation and the ratio between the zoom focus sensitivity and the focus sensitivity. Next, in step S407, the lens control unit 106 adds the correction drive value to the focus position deviation. Then, in step S408, the lens control unit 106 multiplies the focus position deviation to which the correction drive value has been added in step S407, by a PID gain or the like to convert it into a focus operation amount to be output to the focus drive unit 110. Then, the lens control unit 106 outputs the focus operation amount to the focus drive unit 110 and drives the focus lens 105 (performing correction drive with the focus lens as the second optical element).

As described above, in this embodiment, the switching unit 106d switches between using the first optical element and using the second optical element to correct the target position, according to the lens control mode. The lens control mode is an AF control mode or a zoom control mode, but is not limited to this example, and the lens that performs correction drive may be switched according to another mode.

Each embodiment discusses the first optical element as the zoom lens (magnification-varying lens 103) and the second optical element as the focus lens 105, but is not limited to this example and can use another lens combination. For example, the first optical element may be a first zoom lens and the second optical element may be a second zoom lens. That is, the first optical element and the second optical element may be lenses that move during zooming. Alternatively, the first optical element may be a first focus lens and the second optical element may be a second focus lens. That is, the first optical element and the second optical element may be lenses that move during focusing.

One of the first optical element and the second optical element may be a lens such as the magnification-varying lens 103 or the focus lens 105, and the other of the first optical element and the second optical element may be the image sensor 201. In this case, the image sensor 201 is movable along the optical axis direction. The lens control unit 106 or the camera control unit 205 functions as a control apparatus configured to control the first optical element and the second optical element that are movable in the optical axis direction. Both the lens control unit 106 and the camera control unit 205 may cooperate to function as the control apparatus.

Each of the above embodiments has discussed an example in which during lens control, both the magnification-varying lens 103 as the first optical element and the focus lens 105 as the second optical element move, and one of the first optical element and the second optical element is used for correction drive according to the condition. On the other hand, in a case where one of the first optical element and the second optical element is the image sensor 201, it is not essential that the image sensor 201 moves during lens control. That is, during lens control, only a specific lens may be moved in the optical axis direction, and then the image sensor 201 may be moved in the optical axis direction to perform correction. That is, the control unit may move at least one of the first optical element and the second optical element to a target position, and the correction unit may move one of the first optical element and the second optical element in the optical axis direction to correct the target position (control error of the target position).

Each embodiment can more stably reduce a focus shift by switching the lens that performs correction drive according to a condition. Therefore, each embodiment can provide a control apparatus, a lens apparatus, an image pickup apparatus, a control method, and a storage medium, each of which can more properly control the driving of a plurality of lenses.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions.

This application claims priority to Japanese Patent Application No. 2024-085274, which was filed on May 27, 2024, and which is hereby incorporated by reference herein in its entirety.

What is claimed is:

1. A control apparatus configured to control a first optical element and a second optical element that are movable in an optical axis direction, the control apparatus comprising:
at least one processor that executes instructions to:
move at least one of the first optical element and the second optical element to a target position, and
correct a control error of the target position by moving the first optical element or the second optical element in the optical axis direction,
wherein the processor is configured to switch between using the first optical element and using the second optical element to correct the control error of the target position.

2. The control apparatus according to claim 1, wherein the processor is configured to switch between using the first optical element and using the second optical element to correct the control error of the target position, according to a first drive amount of the first optical element and a second drive amount of the second optical element.

3. The control apparatus according to claim 2, wherein the processor is configured to:
correct the control error of the target position using the first optical element in a case where the first drive amount is larger than the second drive amount, and
correct the control error of the target position using the second optical element in a case where the second drive amount is larger than the first drive amount.

4. The control apparatus according to claim 1, wherein the processor is configured to switch between using the first optical element and using the second optical element to correct the control error of the target position, according to a first electrification state of the first optical element and a second electrification state of the second optical element.

5. The control apparatus according to claim 4, wherein the processor is configured to:
correct the control error of the target position using the first optical element in a case where the first electrification state is an electrification ongoing state and the second electrification state is a non-electrification state, and
correct the control error of the target position using the second optical element in a case where the second electrification state is an electrification ongoing state and the first electrification state is a non-electrification state.

6. The control apparatus according to claim 1, wherein the processor is configured to switch between using the first optical element and using the second optical element to correct the control error of the target position, according to a first correctable amount of the first optical element and a second correctable amount of the second optical element.

7. The control apparatus according to claim 6, wherein the processor is configured to:
correct the control error of the target position using the first optical element in a case where the first correctable amount is larger than the second correctable amount, and
correct the control error of the target position using the second optical element in a case where the second correctable amount is larger than the first correctable amount.

8. The control apparatus according to claim 6, wherein each of the first correctable amount and the second correctable amount is a limit amount based on the target position and differs according to an object distance, a focal length, or at least one of positions of the first optical element and the second optical element.

9. The control apparatus according to claim 1, wherein the processor is configured to switch between using the first optical element and using the second optical element to correct the control error of the target position, according to at least one of a first position deviation of the first optical element and a second position deviation of the second optical element.

10. The control apparatus according to claim 9, wherein the processor is configured to:
correct the target position using the first optical element in a case where the first position deviation is smaller than a predetermined value, and
correct the control error of the target position using the second optical element in a case where the first position deviation is larger than the predetermined value.

11. The control apparatus according to claim 1, wherein the control apparatus is provided in a lens apparatus that is attachable to and detachable from an image pickup apparatus, and
wherein the processor is configured to switch between using the first optical element and using the second optical element to correct the control error of the target position, according to a type of the image pickup apparatus.

12. The control apparatus according to claim 1, wherein the processor is configured to switch between using the first optical element and using the second optical element to correct the control error of the target position, according to a shutter mode.

13. The control apparatus according to claim 1, wherein the processor is configured to switch between using the first optical element and using the second optical element to correct the control error of the target position, according to a lens control mode.

14. The control apparatus according to claim 1, wherein the first optical element is a lens movable during zooming, and
wherein the second optical element is a lens movable during focusing.

15. The control apparatus according to claim 1, wherein the first optical element and the second optical element are lenses movable during zooming.

16. The control apparatus according to claim 1, wherein the first optical element and the second optical element are lenses movable during focusing.

17. The control apparatus according to claim 1, wherein the first optical element is a lens, and
wherein the second optical element is an image sensor.

18. A lens apparatus comprising:
the control apparatus according to claim 1; and
the first optical element.

19. An image pickup apparatus comprising:
the control apparatus according to claim 1; and
an image sensor.

20. A control method for controlling a first optical element and a second optical element that are movable in an optical axis direction, the control method comprising:
moving at least one of the first optical element and the second optical element to a target position, and
correcting a control error of the target position by moving the first optical element or the second optical element in the optical axis direction,
wherein correcting the control error includes switching between using the first optical element and using the second optical element to correct the control error of the target position.

21. A non-transitory computer-readable storage medium storing a program that causes a computer to execute the control method according to claim 20.
